(19) United States
(12) Patent Application Publication
(10) Pub. No.: US 2010/0167098 A1
(43) Pub. Date: Jul. 1, 2010

(54) FUEL CELL SYSTEM AND TRANSPORTATION EQUIPMENT INCLUDING THE SAME

(75) Inventors: Kazuyoshi FURUKAWA, Shizuoka (JP); Yasuyuki MURAMATSU, Shizuoka (JP)

Correspondence Address: YAMAHA;C/O KEATING & BENNETT, LLP, 1800 Alexander Bell Drive, SUITE 200, Reston, VA, 20191, US

(73) Assignee: YAMAHA HATSUDOKI KABUSHIKI KAISHA, Iwata-shi (JP)

(21) Appl. No.: 12/645,605

(22) Filed: Dec. 23, 2009

(30) Foreign Application Priority Data
Dec. 26, 2008 (JP) 2008-333440

(51) Int. Cl. H01M 8/04

(52) U.S. Cl. 429/24

(57) ABSTRACT

A fuel cell system prevents leakage of aqueous fuel solution to the cathode while reducing catalyst deterioration in the fuel cell. The fuel cell system includes a fuel cell including an anode and a cathode. An aqueous solution pump supplies the anode with aqueous methanol solution whereas an air pump supplies the cathode with air. Where there is an abnormality in the fuel cell, a CPU stops operation of the aqueous solution pump, and thereafter stops operation of the air pump when a temperature of the fuel cell detected by a cell stack temperature sensor is not higher than a predetermined value. When starting the fuel cell system with an abnormality existing in the fuel cell, the CPU drives the air pump and thereafter drives the aqueous solution pump.

### BACKGROUND OF THE INVENTION

1. Field of the Invention

The present invention relates to a fuel cell system and transportation equipment including such a fuel cell system. More specifically, the present invention relates to a direct methanol fuel cell system and transportation equipment including it.

2. Description of the Related Art

Direct methanol fuel cell systems typically include a fuel-cell cell-stack having of a plurality of fuel cells. As shown in FIG. 16, FIG. 17A and FIG. 17B, for example, a fuel cell 1 includes an electrolyte film 2, an anode 3, a cathode 4, a pair of separators 5, and gaskets 6a, 6b. The anode 3 and the cathode 4 are opposed to each other, sandwiching the electrolyte film 2 in between. The anode 3 is fitted into the gasket 6a whereas the cathode 4 is fitted into the gasket 6b. The separators 5 are opposed to each other, sandwiching therebetween the electrolyte film 2, the anode 3 and the cathode 4. The separators 5 are a common component shared by two mutually adjacent fuel cells 1.

The separator 5 has a main surface which faces the anode 3 and is formed with a serpentine groove 7 for supplying the anode 3 with aqueous methanol solution. Likewise, the separator 5 has a main surface which faces the cathode 4 and is formed with a serpentine groove 7 for supplying the cathode 4 with air.

With such a fuel cell 1, aging deterioration, incidental impact, etc., can cause cracks 8a and 8b which penetrate the separator 5, and/or a tear 8c which penetrates the electrolyte film 2, for example.

As the anode 3 and the cathode 4 become non-separated due to the formation of undesirable passages such as the cracks 8a, 8b and the tear 8c formed in the fuel cell 1, there can be undesirable situations such as leakage of aqueous methanol solution from the anode 3 through the tear 8c in the electrolyte film 2 to the cathode 4, or leakage through the cracks 8a and/or 8b in the separator 5 to the different cathode 4 in the adjacent fuel cell 1. If such a leakage occurs after stoppage of power generation, the fuel is wasted. Also, if the situation is not corrected, these undesirable passages may grow further, increasing the leakage of aqueous methanol solution further, and resulting in increased waste of the fuel.

The risk may be reduced by application of a technique disclosed in JP-A 2004-214004, thereby reducing leakage of aqueous methanol solution to the cathode 4.

The technique disclosed in JP-A 2004-214004 includes steps applicable to a stopping operation of a direct methanol fuel cell system. The steps include stopping a supply of aqueous methanol solution; then supplying an oxidizer gas at a predetermined flow rate for a predetermined amount of time while consuming the resulting electric power with a predetermined load current; and then stopping the supply of the oxidizer gas.

The application of this technique, i.e., supplying air for a predetermined amount of time after the aqueous methanol solution supply has been stopped, reduces the leakage of aqueous methanol solution to the cathode 4.

In this case, however, the air is supplied only for a predetermined amount of time until aqueous methanol solution in the fuel cell 1 has been consumed, and the air supply is stopped right after the power generation ceases. This is problematic since the fuel cell 1 is still hot at the time of the stoppage, which means that the catalysts in the anode 3 and the cathode 4 are also hot and active, at a risk of premature deterioration.

### SUMMARY OF THE INVENTION

Preferred embodiments of the present invention provide a fuel cell system that prevents and minimizes leakage of aqueous fuel solution to the cathode while reducing catalyst deterioration in the fuel cell, and provide transportation equipment including such a fuel cell system.

According to a preferred embodiment of the present invention, a fuel cell system includes a fuel cell including an anode and a cathode, an aqueous solution supply arranged to supply the anode with aqueous fuel solution, a gas supply arranged to supply the cathode with a gas which contains an oxidizer, a cell temperature detector arranged to detect a temperature of the fuel cell, and a controller programmed to stop an operation of the aqueous solution supply, and thereafter to stop an operation of the gas supply when the temperature of the fuel cell detected by the cell temperature detector has reached a temperature not higher than a predetermined value, at a time of stopping power generation.

According to a preferred embodiment of the present invention, the aqueous solution supply is stopped prior to the gas supply when stopping power generation. This makes the pressure on the cathode side greater than on the anode side, pushes the aqueous fuel solution which comes from the anode side to the cathode side back to the anode side, and minimizes the leakage of aqueous fuel solution from the anode side to the cathode side. In cases where the fuel cell has an undesirable passage caused by a crack or the like, and the passage provides uncontrolled communication between the anode side and the cathode side, stopping the gas supply first will make the pressure on the anode side greater than on the cathode side, allow aqueous fuel solution on the anode side to move through the undesirable passage to the anode, and may widen the passage. However, the present fuel cell system can make the pressure on the cathode side greater than the pressure on the anode side thereby preventing the aqueous fuel solution on the anode side from moving through the undesirable passage to the cathode. Therefore, a preferred embodiment of the present invention can prevent widening of the passage and minimize the leakage of aqueous fuel solution after a stoppage of power generation. Hence, a preferred embodiment of the present invention minimizes wasting of aqueous fuel solution. Also, after the aqueous solution supply has been stopped, the gas supply is stopped under the condition that the fuel cell has a temperature not higher than a predetermined value. This allows for sufficient cooling of the fuel cell, and more particularly sufficient cooling of the catalysts included in the anode and in the cathode, keeping the catalysts in a desired state at a reduced pace of deterioration. A preferred embodiment of the present invention is suitably applied in fuel cell systems operated at a high temperature (not lower than about 60° C., for example) in normal operation.

Preferably, the fuel cell system further includes an abnormality detector arranged to detect an abnormality in the fuel cell. With this arrangement, the controller is programmed to stop an operation of the aqueous solution supply, and thereafter stops an operation of the gas supply when the temperature of the fuel cell detected by the cell temperature detector has reached a temperature not higher than the predetermined value, if an abnormality is detected by the abnormality detector. Stopping the gas supply after stopping the aqueous solution supply can reduce widening of the undesirable passage such as a crack in the fuel cell. Thus, a preferred embodiment of the present invention is advantageous in cases where there is an abnormality in the fuel cell caused by a leakage of aqueous fuel solution from the anode side to the cathode side.

Further preferably, the controller is programmed to stop an operation of the gas supply, and thereafter stop an operation of the aqueous solution supply when the temperature of the fuel cell detected by the cell temperature detector has reached a temperature not higher than the predetermined value, if an abnormality is not detected by the abnormality detector. In other words, when the fuel cell is in normal state, the gas supply is stopped first, and thereafter the aqueous solution supply is stopped under the condition that the fuel cell temperature has become not higher than a predetermined value. In this case, the fuel cell is cooled quickly with the aqueous fuel solution which is supplied through the operation of the aqueous solution supply, making it possible to stop power generation quickly. Also, by using different shutdown sequences of the fuel supply and aqueous solution supply depending on the presence and absence of abnormality in the fuel cell, it becomes possible to provide an optimum power generation stopping process suitable for the state of the fuel cell.

Further, preferably, the controller is programmed to drive the gas supply and thereafter drives the aqueous solution supply, when starting the fuel cell system. Driving the gas supply prior to the aqueous solution supply when stating the fuel cell system makes the pressure on the cathode side greater than on the anode side, and pushes aqueous fuel solution which comes from the anode side to the cathode side, back to the anode side. In cases where the fuel cell has an undesirable passage caused by a crack or the like, driving the aqueous solution supply first will make the pressure on the anode side greater than on the cathode side, which can widen the undesirable passage. However, the present fuel cell system can make the pressure on the cathode side greater than the pressure on the anode side, therefore can prevent the widening of the undesirable passage, and as a result, can minimize leakage of aqueous fuel solution from the anode side to the cathode side.

Preferably, the fuel cell system further includes an abnormality detector arranged to detect an abnormality in the fuel cell, the controller is programmed to drive the gas supply and thereafter drives the aqueous solution supply, when starting the fuel cell system, if an abnormality is detected by the abnormality detector. Driving the aqueous solution supply after driving the gas supply prevents widening of the undesirable passage such as a crack in the fuel cell. Therefore, a preferred embodiment of the present invention is advantageous in cases where there is an abnormality in the fuel cell caused by a leakage of aqueous fuel solution from the anode side to the cathode side.

Further preferably, the controller drives the aqueous solution supply and thereafter drives the gas supply, when starting the fuel cell system, if an abnormality of the fuel cell is not detected by the abnormality detector. In other words, when the fuel cell is in normal state, the aqueous solution supply is driven first and thereafter the gas supply is driven. In this case, aqueous fuel solution is supplied quickly to the fuel cell through the operation of the aqueous solution supply, and also, uniform concentration of aqueous fuel solution is achieved quickly on the anode side, facilitating a quick startup of the fuel cell system. Also, by using different startup sequences of the fuel supply and aqueous solution supply depending on the presence and absence of abnormality in the fuel cell, it becomes possible to provide an optimum power generation startup process suitable for the state of the fuel cell.

Further, preferably, the fuel cell system further includes an aqueous solution storage unit arranged to store the aqueous fuel solution. With this arrangement, the abnormality detector includes an aqueous solution amount detector arranged to detect an amount of liquid stored in the aqueous solution storage unit, and an abnormality detector arranged to detect an abnormality in the fuel cell based on a detection result of the aqueous solution amount detector. In cases where there is an abnormality in the fuel cell caused by a leakage of aqueous fuel solution from the anode side to the cathode side, the amount of aqueous fuel solution in the aqueous solution storage unit decreases. Therefore, the abnormality in the fuel cells can be detected easily by detecting the amount of liquid in the aqueous solution storage unit.

Preferably, the fuel cell system further includes a fuel-cell cell-stack which includes a plurality of the fuel cells. With this arrangement, the abnormality detector includes a voltage detector arranged to detect a voltage of the fuel-cell cell-stack, and an abnormality detector arranged to detect an abnormality in the fuel-cell cell-stack based on a detection result of the voltage detector. In cases where there is an abnormality in the fuel cell caused by a leakage of aqueous fuel solution from the anode side to the cathode side, some of the fuel cells become unable to generate power, leading to a decreased voltage in the fuel-cell cell-stack. Therefore, the abnormality in the fuel-cell cell-stack can be detected easily by detecting the voltage in the fuel-cell cell-stack.

Further preferably, the abnormality detector includes a pressure detector arranged to detect a pressure of at least one of the anode and the cathode, and an abnormality detector arranged to detect an abnormality in the fuel cell based on a detection result of the pressure detector. In cases where there is an abnormality in the fuel cell caused by a leakage of aqueous fuel solution from the anode side to the cathode side, pressures on the anode side and the cathode side have abnormal values because of the undesirable communication between the anode and the cathode. Therefore, the abnormality in the fuel cells can be detected easily by detecting the pressure of at least one of the anode and the cathode.

Further, preferably, the abnormality detector includes a cathode temperature detector arranged to detect a temperature of the cathode, and an abnormality detector arranged to detect an abnormality in the fuel cell based on a detection result of the cathode temperature detector. In cases where there is an abnormality in the fuel cell caused by a leakage of aqueous fuel solution from the anode side to the cathode side, the cathode shows a temperature which is not lower than a predetermined value. Therefore, the abnormality in the fuel-cell cell-stack can be detected easily by detecting the cathode temperature.

Preferably, the controller is programmed to stop an operation of the aqueous solution supply, and thereafter to stop an operation of the gas supply when the temperature of the fuel cell detected by the cell temperature detector has reached a temperature not higher than the predetermined value, if there is an abnormality in the fuel cell caused by a leakage of the aqueous fuel solution from the anode side to the cathode side. Stopping the gas supply after stopping the aqueous solution supply prevents widening of the undesirable passage such as a crack in the fuel cell. Thus, such a system is advantageous in cases where there is an abnormality in the fuel cell caused by a leakage of aqueous fuel solution from the anode side to the cathode side.

Transportation equipment is subject to impact during operation. Fuel cell systems for use in the transportation equipment must therefore be designed in consideration of cases where aqueous fuel solution leaks from the anode side to the cathode side. Since preferred embodiments of the present invention are capable of preventing and minimizing leakage of the aqueous fuel solution to the cathode, preferred embodiments of the present invention are suitable for transportation equipment including such a fuel cell system.

The above-described and other elements, features, steps, characteristics, aspects and advantages of the present invention will become clearer from the following detailed description of preferred embodiments of the present invention with reference to the attached drawings.

### BRIEF DESCRIPTION OF THE DRAWINGS

FIG. 1 is a left side view showing a motorbike according to a preferred embodiment of the present invention.

FIG. 2 is a system diagram showing piping of a fuel cell system according to a preferred embodiment of the present invention.

FIG. 3 is a block diagram showing an electrical configuration of a fuel cell system according to a preferred embodiment of the present invention.

FIG. 4 is an exploded perspective view showing an example of fuel cell.

FIG. 5 is a flowchart showing an example of a startup process of a fuel cell system according to a preferred embodiment of the present invention, during a normal condition.

FIG. 6 is a flowchart showing another example of a startup process during a normal condition.

FIG. 7 is a flowchart showing still another example of a startup process during a normal condition.

FIG. 8 is a flowchart showing an example of a process performed during a normal operation.

FIG. 9 is a flowchart showing another example of the process performed during a normal operation.

FIG. 10 is a flowchart showing a still another example of the process performed during a normal operation.

FIG. 11 is a flowchart showing a still another example of the process performed during a normal operation.

FIG. 12 is a flowchart showing a still another example of the process performed during a normal operation.

FIG. 13 is a flowchart showing an example of startup process during an abnormal condition.

FIG. 14 is a flowchart showing an example of power generation stoppage process during a normal condition.

FIG. 15 is a flowchart showing an example of power generation stoppage process during an abnormal condition.

FIG. 16 is an exploded perspective view showing an example of fuel cell which has cracks and a tear.

FIG. 17A is a sectional drawing of a manifold portion of the fuel cell taken in lines A-A in FIG. 16. FIG. 17B is a sectional drawing of a center portion of the fuel cell taken in lines B-B in FIG. 16.

### DETAILED DESCRIPTION OF THE PREFERRED EMBODIMENTS

Hereinafter, preferred embodiments of the present invention will be described with reference to the drawings.

The preferred embodiments are cases where a fuel cell system 100 according to the present invention is equipped in a motorbike 10 as an example of transport equipment.

The description will first cover the motorbike 10. It is noted here that the terms left and right, front and rear, up and down as used in the preferred embodiments of the present invention are determined from the normal state of riding a motorbike, i.e., as viewed by the driver sitting on the seat of the motorbike 10, facing toward a handle 24.

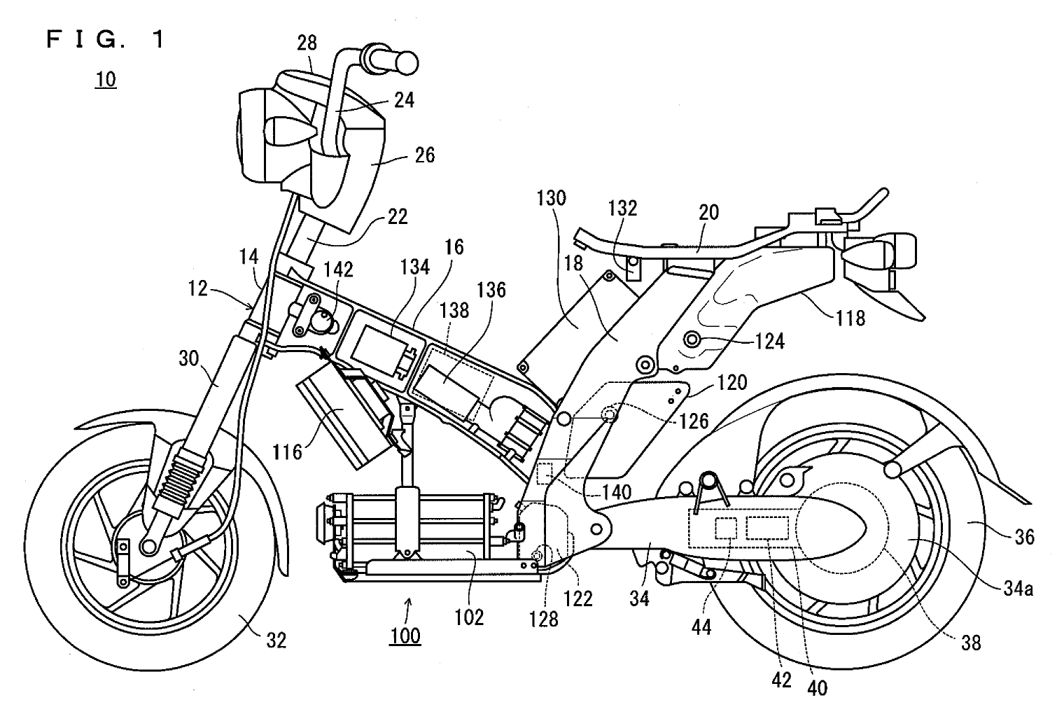

Referring to FIG. 1, the motorbike 10 includes a vehicle frame 12. The vehicle frame 12 includes a head pipe 14, a front frame 16 extending in a rearward and downward direction from the head pipe 14, and a rear frame 18 connected with a rear end of the front frame 16 and rising in a rearward and upward direction. A seat frame 20 is fixed to an upper end of the rear frame 18, for installation of an unillustrated seat.

A steering shaft 22 is pivotably inserted into the head pipe 14. A handle support 26 is provided at an upper end of the steering shaft 22, to which a handle 24 is fixed. A display/operation board 28 is provided on an upper end of the handle support 26.

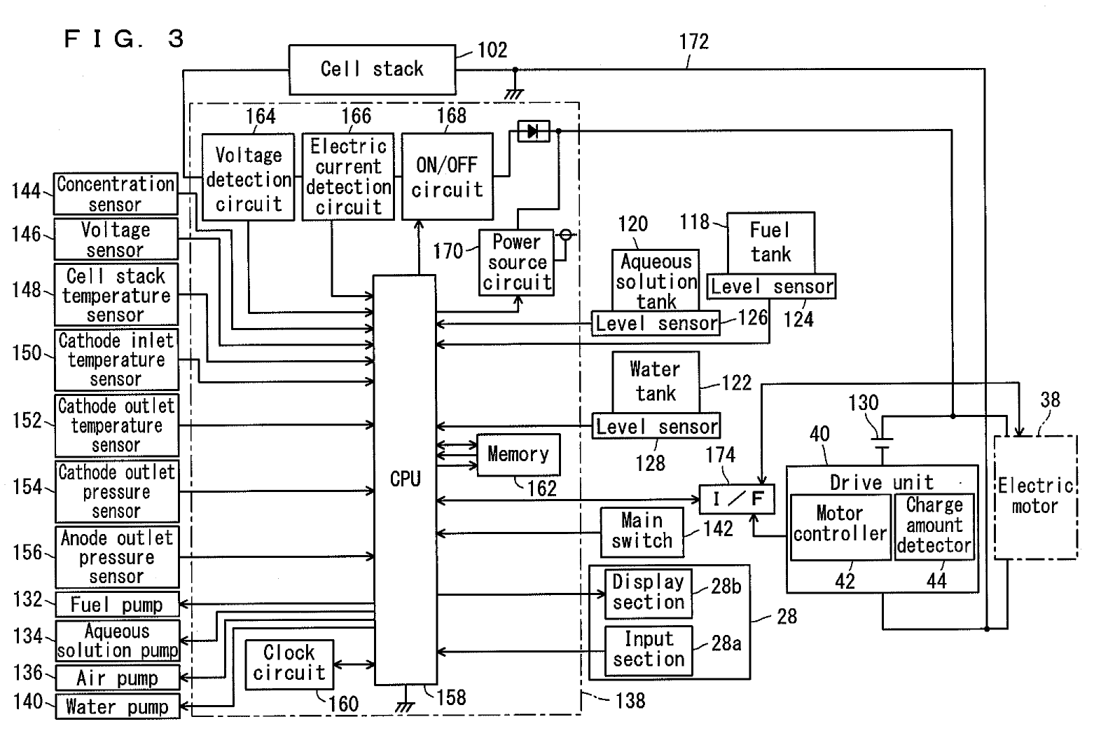

Referring also to FIG. 3, the display/operation board 28 includes a display section 28b including, e.g., a liquid crystal display, etc., for providing a various kinds of information, and input section 28a for use in inputting instructions and various kinds of information.

As shown in FIG. 1, a pair of left and right front forks 30 is provided at a bottom end of the steering shaft 22. Each of the front forks 30 includes a bottom end which supports a front wheel 32 rotatably.

The rear frame 18 includes a lower end which pivotably supports a swing arm (rear arm) 34. The swing arm 34 has a rear end 34a incorporating an electric motor 38 of an axial gap type, for example, which is connected with the rear wheel 36 to drive and rotate the rear wheel 36. Further, the swing arm 34 incorporates a drive unit 40 which is electrically connected with the electric motor 38. The drive unit 40 includes a motor controller 42 programmed to control rotation of the electric motor 38, and a charge-amount detector 44 arranged to detect an amount of electric charge in a secondary battery 130 (to be described later).

The motorbike 10 as described is equipped with a fuel cell system 100 along the vehicle frame 12. The fuel cell system 100 generates electric energy for driving the electric motor 38, system components, etc.

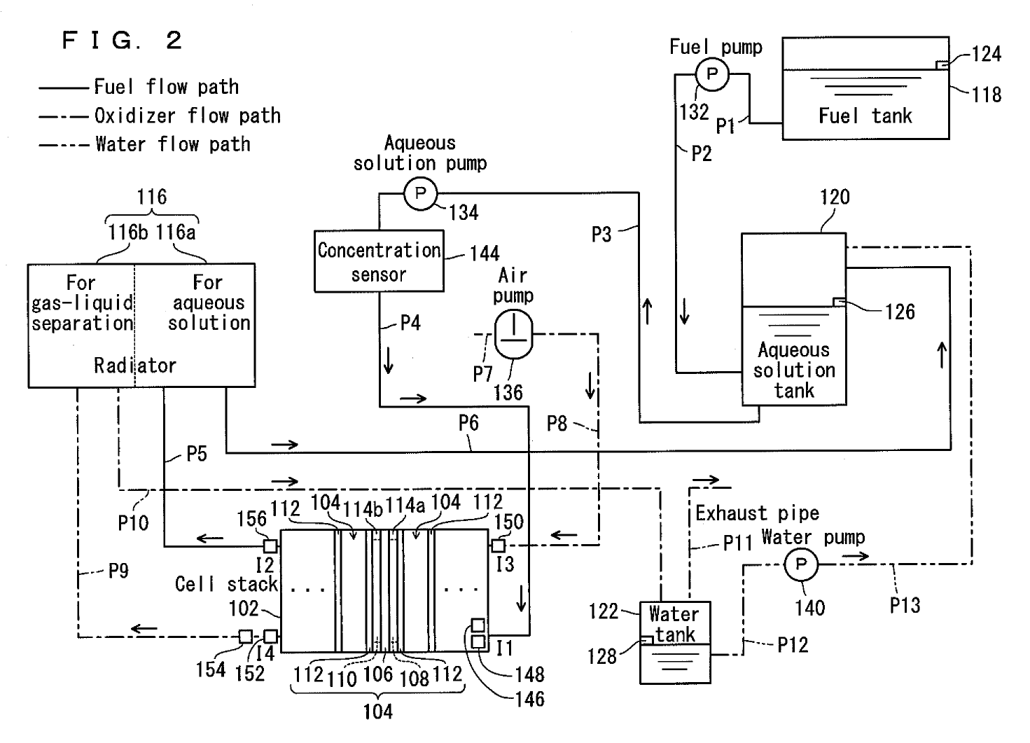

Hereinafter, the fuel cell system 100 will be described with reference to FIG. 1 and FIG. 2.

The fuel cell system 100 is a direct methanol fuel cell system which uses methanol (an aqueous solution of methanol) directly without reformation, for generation of the electric energy (power generation).

The fuel cell system 100 includes a fuel-cell cell-stack (hereinafter simply called cell stack) 102. As shown in FIG. 1, the cell stack 102 is suspended from the front frame 16, and disposed below the front frame 16.

As shown in FIG. 2, the cell stack 102 preferably includes three or a greater number (preferably seventy-six, for example) of fuel cells (individual fuel cells) 104 each capable of generating electric power through electrochemical reactions of hydrogen ions based on methanol and oxygen (oxidizer). These fuel cells 104 are stacked and connected in series.

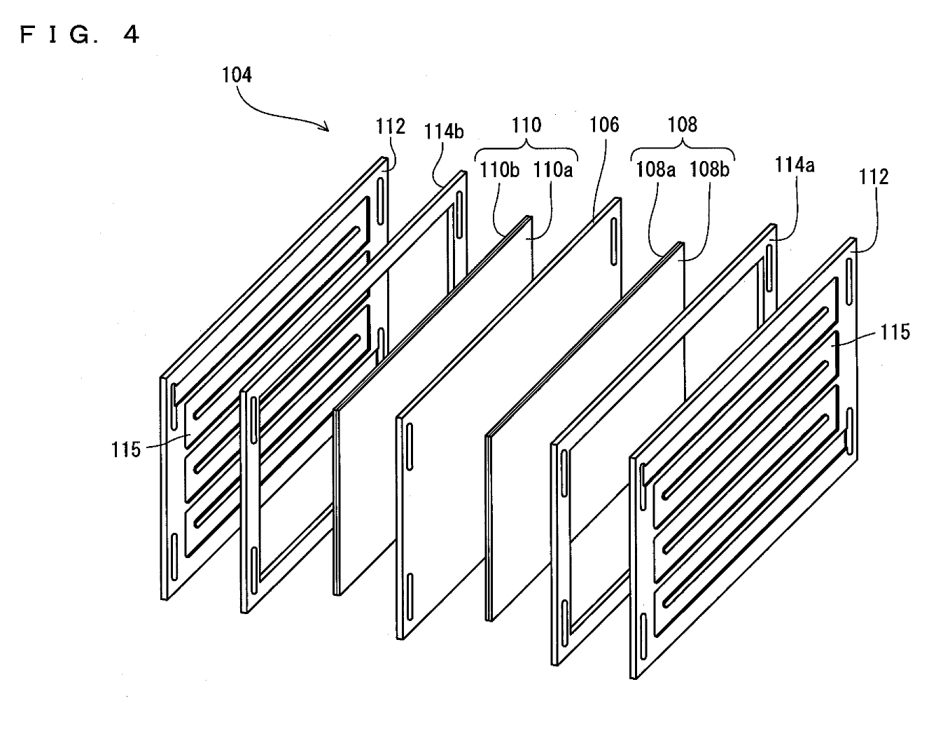

Referring also to FIG. 4, each fuel cell 104 includes an electrolyte film 106 provided by a solid polymer film; a pair of an anode (fuel electrode) 108 and a cathode (air electrode) 110 opposed to each other, sandwiching the electrolyte film 106 in between; and a pair of separators 112 opposed to each other, sandwiching an MEA (Membrane Electrode Assembly) which is an assembly including the electrolyte film 106, the anode 108 and the cathode 110.

The anode 108 includes a platinum catalyst layer 108a provided on the side closer to the electrolyte film 106, and an electrode 108b provided on the side closer to the separator 112. The cathode 110 includes a platinum catalyst layer 110a provided on the side closer to the electrolyte film 106, and an electrode 110b provided on the side closer to the separator 112.

The anode 108 is fitted into a frame-shaped gasket 114a, which is inserted between the electrolyte film 106 and the separator 112, together with the anode 108. Likewise, the cathode 110 is fitted into a frame-shaped gasket 114b, which is inserted between the electrolyte film 106 and the separator 112, together with the cathode 110. Therefore, the anode 108 is shielded by the electrolyte film 106, the separator 112 and the gasket 114a whereas the cathode 110 is shielded by the electrolyte film 106, the separator 112 and the gasket 114b.

The separator 112 is preferably made of an electrically conductive material such as a carbon composite material, and is used as a common element in two mutually adjacent fuel cells 104 (see FIG. 2). The separator 112 has a main surface which faces the cathode 110 and includes a serpentine groove 115 arranged to supply the electrode 110b of the cathode 110 with air as an oxygen- (oxidizer-) containing gas. Likewise, the separator 112 has a main surface which faces the anode 108, and includes a serpentine groove (not illustrated in FIG. 4) arranged to supply the electrode 108b of the anode 108 with aqueous methanol solution.

As shown in FIG. 1, a radiator unit 116 is preferably disposed below the front frame 16, above the cell stack 102.

As shown in FIG. 2, the radiator unit 116 includes an aqueous solution radiator 116a and a gas-liquid separation radiator 116b, which are preferably integral with each other.

Between a pair of plate members of the rear frame 18, a fuel tank 118, an aqueous solution tank 120 and a water tank 122 are disposed in this order from top to down.

The fuel tank 118 contains a methanol fuel (high concentration aqueous solution of methanol) having a high concentration level (preferably containing methanol at approximately 50 wt %) which is used as a fuel for the electrochemical reaction in the cell stack 102. The aqueous solution tank 120 contains aqueous methanol solution which is a solution of the methanol fuel from the fuel tank 118 diluted to a concentration (preferably containing methanol at approximately 3 wt % appropriate for the electrochemical reactions in the cell stack 102). The water tank 122 contains water which is to be supplied to the aqueous solution tank 120.

The fuel tank 118 is provided with a level sensor 124. The aqueous solution tank 120 is provided with a level sensor 126, and the water tank 122 is provided with a level sensor 128. The level sensors 124, 126 and 128 are floating sensors, for example, which detect the height of the liquid surface (liquid level) in the respective tanks.

In front of the fuel tank 118, above the front frame 16, is a secondary battery 130. The secondary battery 130 stores electric energy generated by the cell stack 102, and supplies the stored electric energy to the electric components in response to commands from a controller 138 (to be described later). Above the secondary battery 130, a fuel pump 132 is disposed.

In the left-hand side storage space of the front frame 16, an aqueous solution pump 134 and an air pump 140 are housed. In the right-hand side storage space of the front frame 16, a controller 138 and a water pump 140 are disposed.

A main switch 142 is disposed in the front frame 16. Turning on the main switch 142 supplies the controller 138 with an operation start command whereas turning off the main switch 142 supplies the controller 138 with an operation stop command. If the main switch 142 is turned off while the cell stack 102 is in power generating operation, the controller 138 is supplied with an operation stop command and a power generation stop command.

As shown in FIG. 2, the fuel tank 118 and the fuel pump 132 are connected with each other by a pipe P1. The fuel pump 132 and the aqueous solution tank 120 are connected with each other by a pipe P2. The aqueous solution tank 120 and the aqueous solution pump 134 are connected with each other by a pipe P3. The aqueous solution pump 134 and the cell stack 102 are connected with each other by a pipe P4. The pipe P4 is connected with an anode inlet I1 of the cell stack 102. When driving the aqueous solution pump 134 aqueous methanol solution is supplied to the cell stack 102. The pipe P4 is provided with a concentration sensor 144 arranged to detect a concentration of aqueous methanol solution (a methanol ratio in aqueous methanol solution). The concentration sensor 144 is provided by an ultrasonic sensor, for example. The ultrasonic sensor detects a propagation time (propagation velocity) of an ultrasonic wave, which varies in accordance with aqueous methanol solution concentration, in the form of a voltage value. Based on the voltage value, the controller 138 detects a concentration of the aqueous methanol solution.

Near the anode inlet I1 of the cell stack 102, there is provided a voltage sensor 146 arranged to detect a concentration of aqueous methanol solution supplied to the cell stack 102. The voltage sensor 146 detects an open circuit voltage of the fuel cell 104 which varies in accordance with the concentration of aqueous methanol solution. Based on the open circuit voltage, the controller 138 detects the concentration of the aqueous methanol solution supplied to the cell stack 102.

Also, near the anode inlet I1 of the cell stack 102, a temperature sensor 148 is arranged to detect the temperature of the aqueous methanol solution, i.e., the temperature of the cell stack 102.

The cell stack 102 and the aqueous solution radiator 116a are connected with each other by a pipe P5. The radiator 116a and the aqueous solution tank 120 are connected with each other by a pipe P6. The pipe P5 is connected with an anode outlet I2 of the cell stack 102.

The pipes P1 through P6 serve primarily as a flow path for the fuel.

The air pump 136 is connected with a pipe P7. The air pump 136 and the cell stack 102 are communicated with each other by a pipe P8. The pipe P8 is connected with a cathode inlet I3 of the cell stack 102. Driving the air pump 136 supplies the cell stack 102 with air as an oxygen- (oxidizer-) containing gas, from outside.

The cell stack 102 and the gas-liquid separation radiator 116b are connected with each other by a pipe P9. The radiator 116b and the water tank 122 are connected with each other by a pipe P10. The water tank 122 is provided with a pipe (exhaust pipe) P11. The pipe P9 is connected with a cathode outlet I4 of the cell stack 102. The pipe P11 is provided at an exhaust outlet of the water tank 122 and discharges exhaust from the cell stack 102 to the outside.

The pipes P7 through P11 serve primarily as a flow path for the oxidizer.

The water tank 122 and the water pump 140 are connected with each other by a pipe P12. The water pump 140 and the aqueous solution tank 120 are communicated with each other by a pipe P13.

The pipes P12, P13 serve as a flow path for water.

Further, a cathode inlet temperature sensor 150 is provided near the cathode inlet I3. A cathode outlet temperature sensor 152 and a cathode outlet pressure sensor 154 are provided near the cathode outlet I4. An anode outlet pressure sensor 156 is provided near the anode outlet I2.

Next, reference will be made to FIG. 3 to describe an electric configuration of the fuel cell system 100.

The controller 138 of the fuel cell system 100 includes a CPU 158, a clock circuit 160, a memory 162, a voltage detection circuit 164, an electric current detection circuit 166, an ON/OFF circuit 168, and a power source circuit 170.

The CPU 158 performs necessary calculations, and controls operations of the fuel cell system 100. The clock circuit 160 provides the CPU 158 with a clock signal. The memory 162, which is provided by, e.g., an EEPROM, stores programs and data, calculation data, etc., for controlling the operations of the fuel cell system 100. The voltage detection circuit 164 detects a voltage in the cell stack 102. The current detection circuit 166 detects an electric current which passes through the electric circuit 172. The ON/OFF circuit 168 opens and closes the electric circuit 172. The power source circuit 170 provides the electric circuit 172 with a predetermined voltage.

The CPU 158 of the controller 138 is supplied with input signals from the main switch 142 and the input section 28a. The CPU 158 is also supplied with detection signals from the level sensors 124, 126, 128, and from the concentration sensor 144, the voltage sensor 146, the cell stack temperature sensor 148, the cathode inlet temperature sensor 150, the cathode outlet temperature sensor 152, the cathode outlet pressure sensor 154 and the anode outlet pressure sensor 156. The CPU 158 is also supplied with voltage detection values from the voltage detection circuit 164 and electric current detection values from the current detection circuit 166.

The CPU 158 controls system components such as the fuel pump 132, the aqueous solution pump 134, the air pump 136, the water pump 140, etc. In the present preferred embodiment, the aqueous solution pump 134 and the air pump 136 are supplied with output settings so that operating the aqueous solution pump 134 and the air pump 136 will create a higher pressure on the anode 108 side than on the cathode 110 side.

The CPU 158 also controls the display section 28b to provide the driver with various kinds of information. Further, CPU 158 also controls the ON/OFF circuit 168 which opens and closes the electric circuit 172.

The secondary battery 130 complements the output from the cell stack 102 by being charged with electric energy from the cell stack 102 and by discharging the electric energy to supply power to the electric motor 38, the system components, etc.

The CPU 158 receives charge-amount detection values from the charge-amount detector 44 via an interface circuit 174. Using the inputted charge-amount detection value and the capacity of the secondary battery 130, the CPU 158 calculates a charge rate of the secondary battery 130.

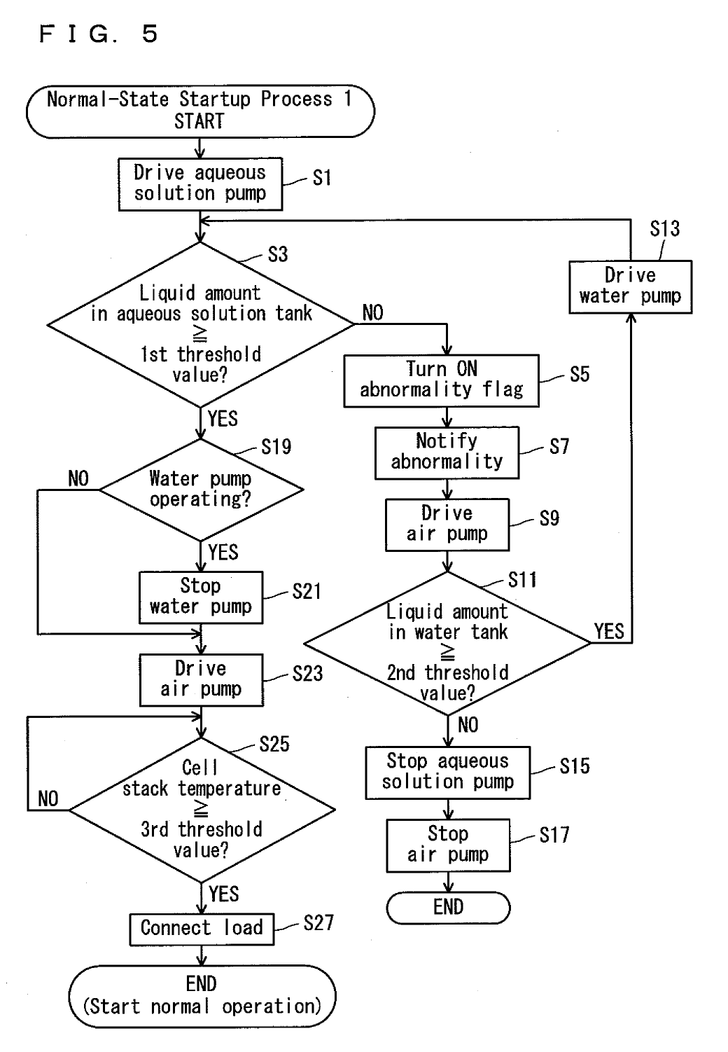

The memory 162, which serves as the storage device, stores programs for execution of operations shown in FIG. 5 through FIG. 15, various calculation values, various detection values, a first through eleventh threshold values, an abnormality flag which indicates presence or absence of an abnormality in the fuel cell 104 (cell stack 102), etc.

In the present preferred embodiment, the aqueous solution supply preferably includes the aqueous solution pump 134. The gas supply preferably includes the air pump 136. The controller includes the CPU 158. The abnormality detector preferably includes the CPU 158. The cell stack temperature sensor 148 preferably serves as the cell temperature detector. The aqueous solution tank 120 preferably serves as the aqueous solution storage unit. The level sensor 126 preferably serves as the aqueous solution amount detector. The voltage detection circuit 164 preferably serves as the voltage detector. The cathode outlet pressure sensor 154 and the anode outlet pressure sensor 156 preferably serve as the pressure detector. The cathode inlet temperature sensor 150 and the cathode outlet temperature sensor 152 preferably serve as the cathode temperature detector.

Referring to FIG. 5, description will now cover a startup process (Startup Process 1) performed when the fuel cell system 100 is in a normal state (when the abnormality flag is OFF).

The normal-time startup process of the fuel cell system 100 is commenced, when the abnormality flag is OFF, the main switch 142 is ON, and the charge-amount detector 44 has detected that the secondary battery 130 has a charge rate value smaller than a predetermined value (preferably about 40%, for example).

First, the CPU 158 starts the aqueous solution pump 134 to supply aqueous methanol solution to the anode 108 in the cell stack 102 (Step S1). Then, the CPU 158 determines whether or not the amount of liquid in the aqueous solution tank 120 detected by the level sensor 126 is not smaller than a first threshold value (preferably about 200 cc, for example) (Step S3). If the amount of liquid in the aqueous solution tank 120 is smaller than the first threshold value, the CPU 158 turns ON the abnormality flag (Step S5), and then the CPU 158 makes the display section 28b display a message that there is an abnormality in the fuel cells 104 caused by a leakage of aqueous methanol solution from the cathode 108 side to the anode 110 side (Step S7). Then, the CPU 158 drives the air pump 136 to supply air to the cathode 110 of the cell stack 102 (Step S9). This operation decreases a pressure difference between the anode 108 and the cathode 110 and thereby reduces the amount of leak of the aqueous methanol solution.

Then, the CPU 158 determines whether or not the amount of liquid in the water tank 122 detected by the level sensor 128 is not smaller than a second threshold value (preferably 500 cc) (Step S11). If the amount of liquid in the water tank 122 is not smaller than the second threshold value, the CPU 158 drives the water pump 140 (Step S13). This brings the aqueous methanol solution which has leaked to the cathode 110 back into the aqueous solution tank 120. Then, the process returns to Step S3.

On the other hand, if Step S11 determines that the amount of liquid in the water tank 122 is smaller than the second threshold value, the CPU 158 stops the aqueous solution pump 134 (Step S15), then the CPU 158 stops the air pump 136 (Step S17), and brings the process to an end. As described, power generation is stopped if the aqueous methanol solution which leaked to the cathode 110 has been lost for any reason.

On the other hand, if Step S3 determines that the amount of liquid in the aqueous solution tank 120 is not smaller than the first threshold value, the CPU 158 determines whether or not the water pump 140 is in operation (Step S19). If the water pump 140 is in operation, the CPU 158 stops the water pump 140 (Step S21), and then the CPU 158 drives the air pump 136 (Step S23). If Step S19 determines that the water pump 140 is not in operation, the process goes to Step S23 directly.

After Step S23, the CPU 158 determines whether or not the temperature of the cell stack 102 detected by the cell stack temperature sensor 148 is not lower than a third threshold value (preferably about 45° C., for example) (Step S25). The CPU 158 waits until the temperature of the cell stack 102 becomes not lower than the third threshold value. When the temperature of the cell stack 102 becomes not lower than the third threshold value, the CPU 158 turns ON the ON/OFF circuit 170 to connect the cell stack 102 with the electric motor 38 as a load (Step S27), whereupon a normal operation is started.

As described, when the fuel cell 104 is in its normal state, the aqueous solution pump 134 is driven first to supply aqueous methanol solution quickly to the cell stack 102, and also to achieve uniform concentration of aqueous methanol solution quickly in the anode 108. This accomplishes a quick startup of the fuel cell system 100.

If there is an abnormality in the fuel cell 104 caused by a leakage of aqueous methanol solution from the anode 108 side to the cathode 110 side, there is a decrease in aqueous methanol solution in the aqueous solution tank 120. Therefore, the abnormality in the fuel cell 104 can be detected easily by detecting the amount of liquid in the aqueous solution tank 120. The abnormality can be detected more easily in the present preferred embodiment because the aqueous solution tank 120 is disposed at a higher level than the cell stack 102.

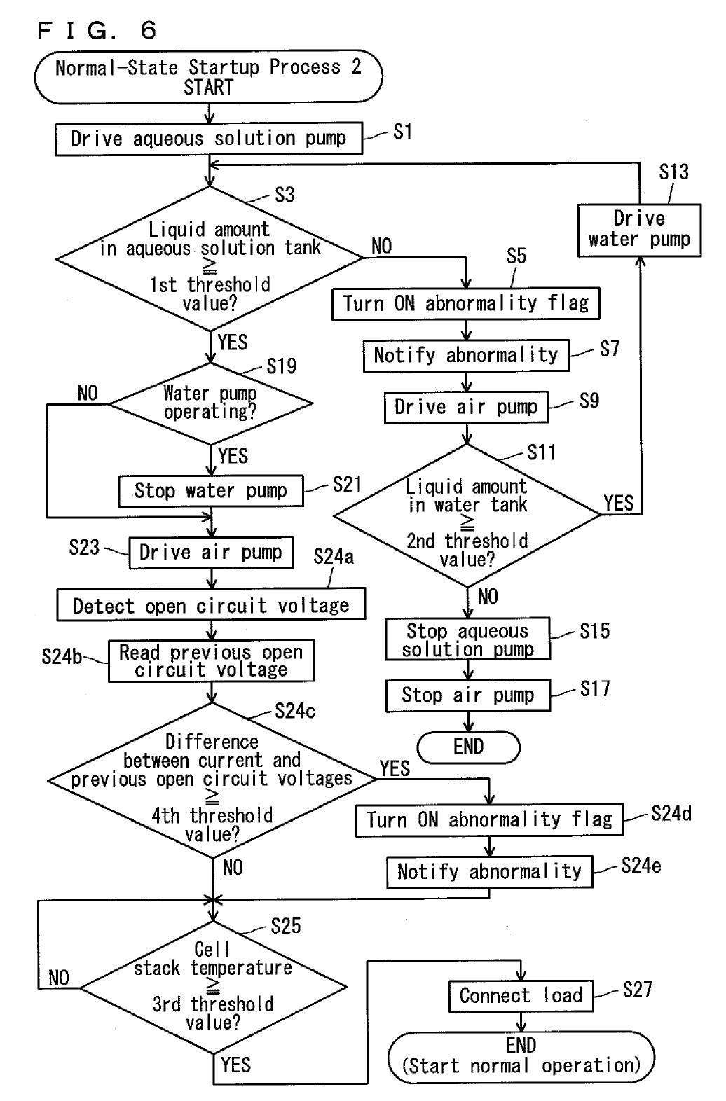

Next, reference will be made to FIG. 6 to describe another startup process (Startup Process 2) performed when the fuel cell system 100 is in a normal state (when the abnormality flag is OFF). The operation example shown in FIG. 6 is preferably the same as the example in FIG. 5, with a difference that Steps S24a through 24e are inserted between Step S23 and Step S25. All the other steps are the same as in the operation example given in FIG. 5, so they are indicated by the same reference symbols and their description will not be repeated.

In the operation in FIG. 6, Step S23 is followed by a step of detection by the voltage detection circuit 164, of an open circuit voltage in the cell stack 102, and a storage of the detected value by the memory 162 (Step S24a). Then, the CPU 158 reads the previous open circuit voltage detection value from the memory 162 (Step S24b). The CPU 158 determines whether or not a difference between the current open circuit voltage detection value and the previous detection value is not smaller than a fourth threshold value (preferably about 18 V, for example) (Step S24c). If the difference in the detection values is not smaller than the fourth threshold value, the CPU 158 turns ON the abnormality flag (Step S24d). Then, the CPU 158 makes the display section 28b notify the presence of an abnormality (Step S24e), and the process goes to Step S25. On the other hand, if Step S24c determines that the difference in the detection values is smaller than the fourth threshold value, the process goes to Step S25 directly.

This operation example provides the same advantages as the one in FIG. 5.

A leak of aqueous methanol solution disables some of the fuel cells 104, resulting in a decrease in the open circuit voltage of the cell stack 102. Therefore, it is possible to determine the presence and absence of abnormality in the cell stack 102 (fuel cells 104) based on the open circuit voltage in the cell stack 102. It is also possible to differentiate abnormalities caused by leakage of the liquid from those caused by deterioration of the cell stack 102 itself, by making a determination based on the difference between the current and the previous detection values. This eliminates diagnostic mistakes.

It should be noted here that the abnormality detection in the cell stack 102 (fuel cells 104) may be based on comparison between the open circuit voltage of the cell stack 102 and a pre-established value, or based on a rate of change in the open circuit voltage.

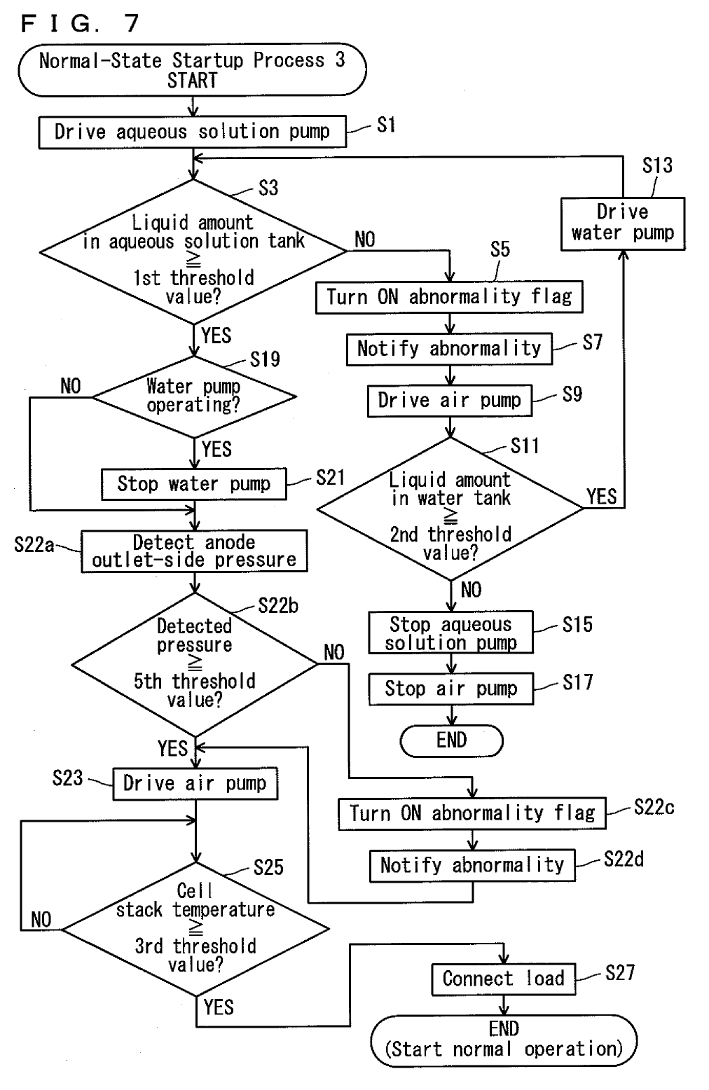

Next, reference will be made to FIG. 7 to describe still another startup process (Startup Process 3) performed when the fuel cell system 100 is in a normal state (when the abnormality flag is OFF). The operation example shown in FIG. 7 is preferably the same as the example given in FIG. 5, with a difference that Steps S22a through 22d are inserted between Step S21 and Step S23. All the other steps are the same as in the operation example given in FIG. 5, so they are indicated by the same reference symbols and their description will not be repeated.

Step S21 is followed by a step of detection by the anode outlet pressure sensor 156, of a pressure on the outlet side of the anode 108 (Step S22a). The CPU 158 determines whether or not the detected value is not smaller than a fifth threshold value (preferably about 50 kPa, for example) (Step S22b). If the detected value is smaller than the fifth threshold value, the CPU 158 turns ON the abnormality flag (Step S22c). Then, the CPU 158 makes the display section 28b notify the presence of an abnormality (Step S22d), and the process goes to Step S23. On the other hand, if Step S22b determines that the detected pressure value is not smaller than the fifth threshold value, the process goes to Step S23 directly.

This operation example also provides the same advantages as the one in FIG. 5.

Also, if there is an abnormality in the fuel cell 104 caused by a leakage of aqueous fuel solution from the anode 108 side to the cathode 110 side, a pressure on the anode 108 side and a pressure on the cathode 110 side come in an abnormal range because of undesirable communication between the anode 108 and the cathode 110 caused by a crack or the like. On the anode 108 side, the pressure on the outlet side of the anode 108 becomes lower than a predetermined value (the fifth threshold value). Therefore, abnormality in the fuel cell 104 can be detected easily by detecting the pressure on the outlet side of the anode 108.

It should be noted here that the abnormality detection in the fuel cells 104 may be based on an amount of change or a rate of change in the pressure on the outlet side of the anode 108.

Also, when there is an abnormality in the fuel cell 104, the pressure on the outlet side of the cathode 110 becomes lower than a predetermined value. Therefore, abnormalities in the fuel cells 104 may be detected based on the pressure on the outlet side of the cathode 110.

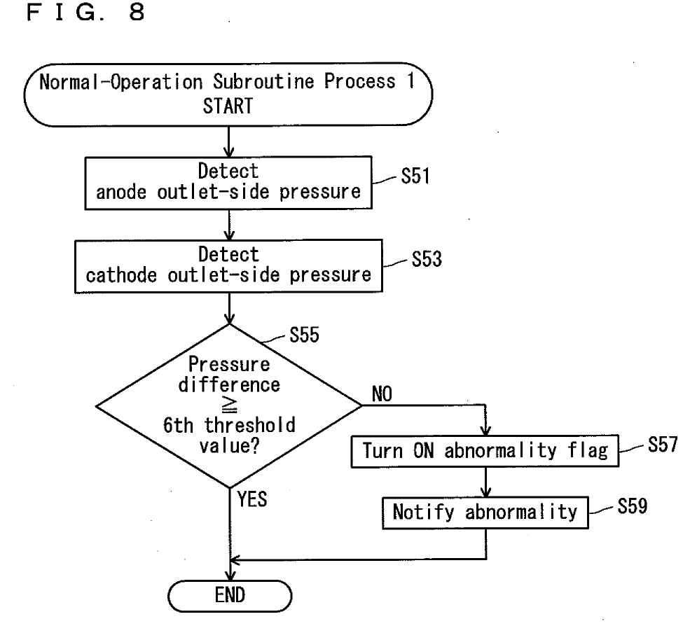

Next, reference will be made to FIG. 8 to describe a process (Normal-Operation Subroutine Process 1) performed during a normal operation (steady operation) of the fuel cell system 100.

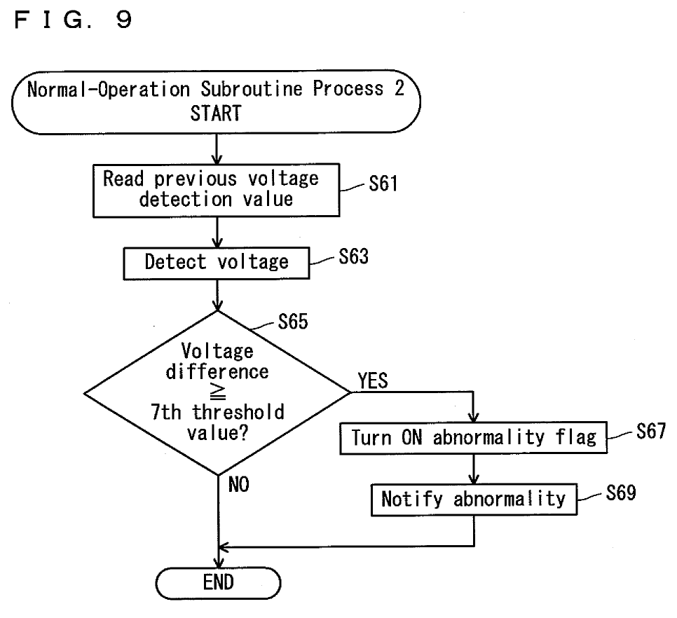

This process is repeated at a predetermined time interval during normal operation. The process may be performed not only during normal operation but any time when both of the aqueous solution pump 134 and the air pump 136 are in operation. The same applies to process examples given in FIG. 9 through FIG. 12.

First, the anode outlet pressure sensor 156 detects a pressure on the outlet side of the anode 108 (Step S51) whereas the cathode outlet pressure sensor 154 detects a pressure on the outlet side of the cathode 110 (Step S53). The CPU 158 determines whether or not a difference between these pressures is not smaller than a sixth threshold value (preferably about 10 kPa, for example) (Step S55). If the pressure difference is smaller than the sixth threshold value, the CPU 158 turns ON the abnormality flag (Step S57). The CPU 158 causes the display section 28b notify the presence of an abnormality (Step S59), and brings the process to an end. On the other hand, if Step S55 determines the pressure difference between the two is not smaller than the sixth threshold value, CPU 158 brings the process to an end.

This operation example is suitable for cases where the aqueous solution pump 134 and the air pump 136 have output settings to make the pressure on the anode 108 greater than on the cathode 110 by a value not smaller than a predetermined value (the sixth threshold value). In this case, the pressure difference which is smaller than the sixth threshold value will lead to a determination that there is an abnormality in the fuel cell 104 caused by a leakage of aqueous methanol solution from the anode 108 side to the cathode 110 side, so it is easy to detect an abnormality in the fuel cell 104.

It should be noted here that the abnormality detection in the fuel cells 104 may be based on a rate of change in the difference between the pressure on the outlet side of the anode 108 and the pressure on the outlet side of the cathode 110.

Reference will now be made to FIG. 9 to describe another process (Normal-Operation Subroutine Process 2) performed during a normal operation of the fuel cell system 100.

First, the CPU 158 reads the previous voltage detection value from the memory 162 (Step S61). If there is no storage of the previous detection value, a predetermined value is used. Then, the voltage detection circuit 166 detects a voltage of the cell stack 102 at the current time (Step S63), and the CPU 158 determines whether or not a difference between the two voltage values is not smaller than a seventh threshold value (preferably about 0.1 V, for example) (Step S65). If there is a decrease in the voltage of the cell stack 102, and the voltage difference becomes not smaller than the seventh threshold value, the CPU 158 determines that there is an abnormality in the fuel cell 104 caused by a leakage of aqueous methanol solution from the anode 108 side to the cathode 110 side, and turns ON the abnormality flag (Step S67). Then, the CPU 158 makes the display section 28b notify the presence of an abnormality (Step S69), and brings the process to an end. On the other hand, if Step S65 determines that the voltage difference is smaller than the seventh threshold value, CPU 158 brings the process to an end.

If there is an abnormality in the fuel cell 104 caused by a leakage of aqueous methanol solution from the anode 108 side to the cathode 110 side, some of the fuel cells 104 become unable to generate power, resulting in decrease in the voltage of the cell stack 102. Therefore, the abnormality in the fuel cell 104 (cell stack 102) can be detected easily by detecting the voltage of the cell stack 102.

It is also possible to differentiate abnormalities caused by leakage of the liquid from those caused by deterioration of the cell stack 102 itself, by making a determination based on the difference between the current and the previous voltage detection values. This eliminates diagnostic mistakes.

It should be noted here that the abnormality detection in the cell stack 102 (fuel cells 104) may be based on comparison between the voltage detection value of the cell stack 102 and a pre-established value, or on a rate of change in the voltage detection value.

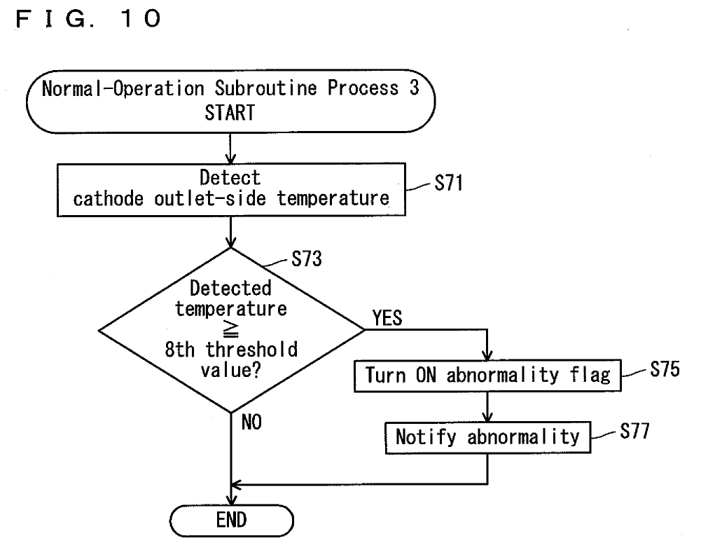

Next, reference will be made to FIG. 10 to describe a process (Normal-Operation Subroutine Process 3) performed during a normal operation of the fuel cell system 100.

First, the cathode outlet temperature sensor 152 detects a temperature on the outlet side of the cathode 110 (Step S71). The CPU 158 determines whether or not the detected temperature is not lower than an eighth threshold value (preferably about 80° C., for example) (Step S73). If the detected temperature is not lower than the eighth threshold value, the CPU 158 turns ON the abnormality flag (Step S75). The CPU 158 makes the display section 28b notify the presence of an abnormality (Step S77), and brings the process to an end. On the other hand, if Step S73 determines that the detected temperature is lower than the eighth threshold value, the CPU 158 brings the process to an end.

If there is an abnormality in the fuel cell 104 caused by a leakage of aqueous methanol solution from the anode 108 side to the cathode 110 side, aqueous methanol solution burns on the cathode 110. This causes the temperature of exhaust from the cathode 110 to be higher than normal, to become not lower than the eighth threshold value. Therefore, the abnormality in the fuel cells 104 can be detected easily by detecting the outlet temperature of the cathode 110.

It should be noted here that the abnormality detection in the fuel cells 104 may be based on an amount of change or a rate of change in the temperature on the outlet side of the cathode 110.

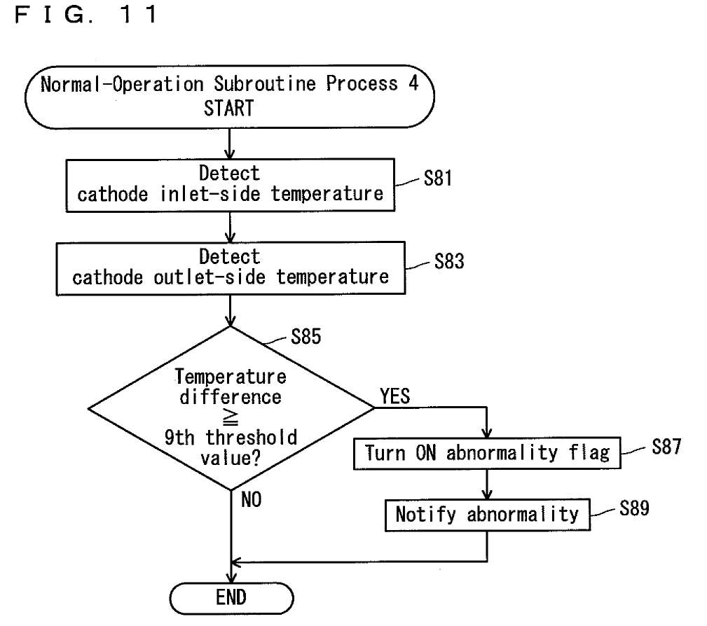

Reference will now be made to FIG. 11 to describe another process (Normal-Operation Subroutine Process 4) performed during a normal operation of the fuel cell system 100.

First, the cathode inlet temperature sensor 150 detects a temperature on the inlet side of the cathode 110 (Step S81) whereas the cathode outlet temperature sensor 152 detects a temperature on the outlet side of the cathode 110 (Step S83). The CPU 158 determines whether or not a difference between the detected temperatures is not smaller than a ninth threshold value (preferably about 20° C., for example) (Step S85). If the difference between the detected temperatures is not smaller than the ninth threshold value, the CPU 158 turns ON the abnormality flag (Step S87). The CPU 158 causes the display section 28b notify the presence of an abnormality (Step S89), and brings the process to an end. If Step S85 determines that the difference between the detected temperatures is smaller than the ninth threshold value, the CPU 158 brings the process to an end.

If there is an abnormality in the fuel cell 104 caused by a leakage of aqueous methanol solution from the anode 108 side to the cathode 110 side, aqueous methanol solution burns on the cathode 110. This increases the temperature of exhaust from the cathode 110 to exceed a normal value, causing the temperature on the outlet side of the cathode 110 to be higher than the temperature on the inlet side thereof, by a value not smaller than the ninth threshold value. Therefore, the abnormality in the fuel cells 104 can be detected easily by detecting the difference between the inlet temperature and the outlet temperature of the cathode 110.

It should be noted here that the abnormality detection in the fuel cells 104 may be based on a rate of change in the temperature difference between the inlet side and the outlet side of the cathode 110.

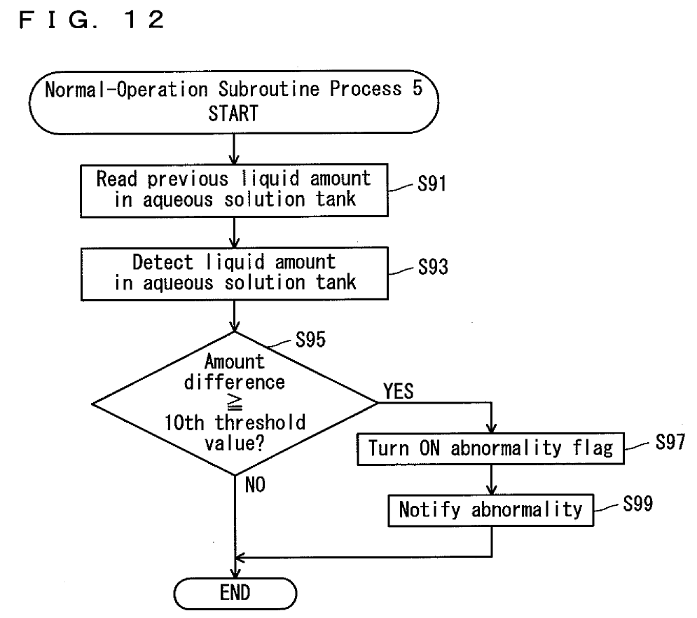

Reference will now be made to FIG. 12 to describe still another process (Normal-Operation Subroutine Process 5) performed during normal operation of the fuel cell system 100.

First, the CPU 158 reads the previously detected amount of liquid in the aqueous solution tank 120 from the memory 162 (Step S91). The level sensor 126 detects a current amount of liquid in the aqueous solution tank 120 (Step S93). The CPU 158 determines whether or not a difference between the two liquid amounts is not smaller than a tenth threshold value (preferably about 300 cc, for example) (Step S95). If there is a difference which is not smaller than the tenth threshold value, the CPU 158 turns ON the abnormality flag (Step S97). Then, the CPU 158 causes the display section 28b notify the presence of an abnormality (Step S99), and brings the process to an end. If Step S95 determines that the difference in the amount is smaller than the tenth threshold value, the CPU 158 brings the process to an end.

If there is an abnormality in the fuel cell 104 caused by a leakage of aqueous methanol solution from the anode 108 side to the cathode 110 side, the amount of aqueous methanol solution in the aqueous solution tank 120 decreases at a greater rate than in normal state. Therefore, the abnormality in the fuel cells 104 can be detected easily based on the difference between the previous and the current detection values of the aqueous methanol solution.

It is also possible to differentiate abnormalities caused by leakage of the liquid from those caused by deterioration of the cell stack 102 itself, by making a determination based on the difference between the current and the previous detection values. This eliminates diagnostic mistakes.

It should be noted here that the abnormality detection in the fuel cells 104 may be based on a rate of change in the amount of aqueous methanol solution in the aqueous solution tank 120.

Also, the abnormality detection in the fuel cells 104 may be based on an amount of change or a rate of change in the amount of the liquid in the water tank 122. Further, the abnormality detection in the fuel cells 104 may be based on an amount of flow of aqueous methanol solution near the anode outlet I2 of the cell stack 102.

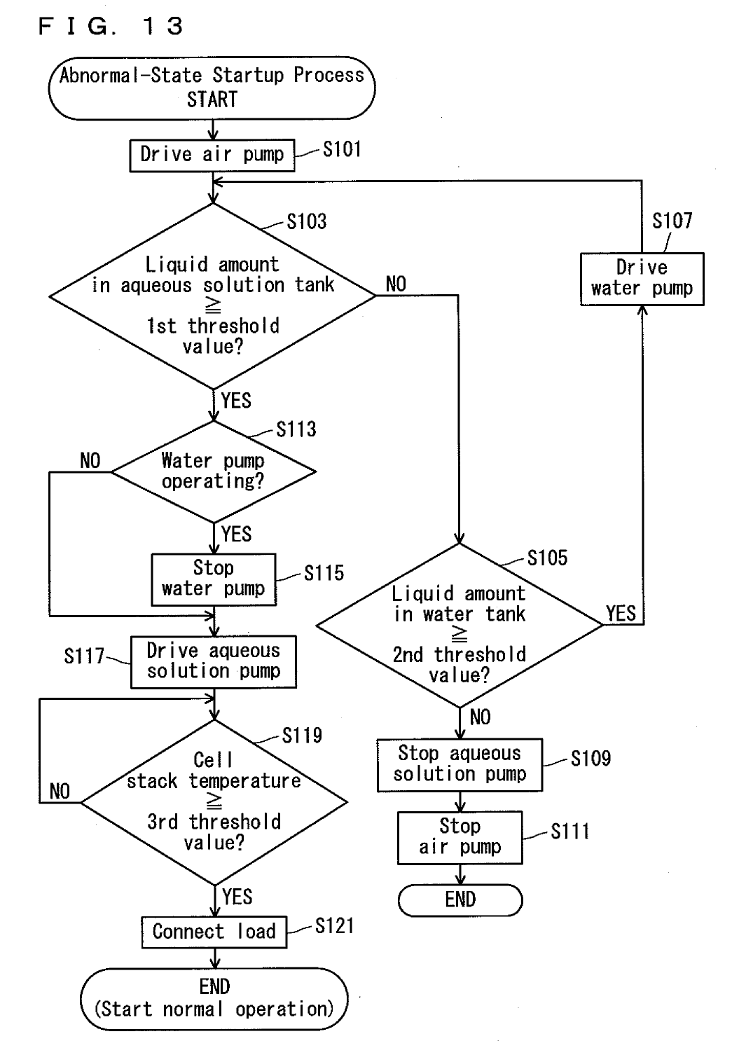

Reference will now be made to FIG. 13 to describe a startup process when the fuel cell system 100 is in an abnormal state (when the abnormality flag is ON).

The abnormal-time startup process of the fuel cell system 100 is commenced, when the abnormality flag is ON, the main switch 142 is ON, and the charge-amount detector 44 has detected that the secondary battery 130 has a charge rate value smaller than a predetermined value (preferably about 40%, for example).

First, the CPU 158 starts the air pump 136 to supply air to the cathode 110 in the cell stack 102 (Step S101). Then, the CPU 158 determines whether or not the amount of liquid in the aqueous solution tank 120 detected by the level sensor 126 is not smaller than the first threshold value (preferably about 200 cc, for example) (Step S103). If the amount of liquid in the aqueous solution tank 120 is smaller than the first threshold value, the CPU 158 determines whether or not the amount of liquid in the water tank 122 detected by the level sensor 128 is not smaller than the second threshold value (preferably about 500 cc, for example) (Step S105). If the amount of liquid in the water tank 122 is not smaller than the second threshold value, the CPU 158 drives the water pump 140 (Step S107). This operation brings the aqueous methanol solution which has leaked to the cathode 110 back to the aqueous solution tank 120. Then, the process returns to Step S103.

On the other hand, if Step S105 determines that the amount of liquid in the water tank 122 is smaller than the second threshold value, the CPU 158 stops the aqueous solution pump 134 (Step S109), then the CPU 158 stops the air pump 136 (Step S111), and brings the process to an end. As described, power generation is stopped if the aqueous methanol solution which leaked to the cathode 110 has been lost for any reason.

On the other hand, if Step S103 determines that the amount of liquid in the aqueous solution tank 120 is not smaller than the first threshold value, the CPU 158 determines whether or not the water pump 140 is in operation (Step S113). If the water pump 140 is in operation, the CPU 158 stops the water pump 140 (Step S115), and then the CPU 158 drives the aqueous solution pump 134 to supply aqueous methanol solution to the anode 108 in the cell stack 102 (Step S117). If Step S113 determines that the water pump 140 is not in operation, the process goes to Step S117 directly.

After Step S117, the CPU 158 determines whether or not the temperature of the cell stack 102 detected by cell stack temperature sensor 148 is not lower than the third threshold value (preferably about 45° C., for example) (Step S119). The CPU 158 waits until the temperature of the cell stack 102 becomes not lower than the third threshold value. When the temperature of the cell stack 102 becomes not lower than the third threshold value, the CPU 158 turns ON the ON/OFF circuit 170 to connect the cell stack 102 with the electric motor 38 as the load (Step S121), whereupon a normal operation is started.

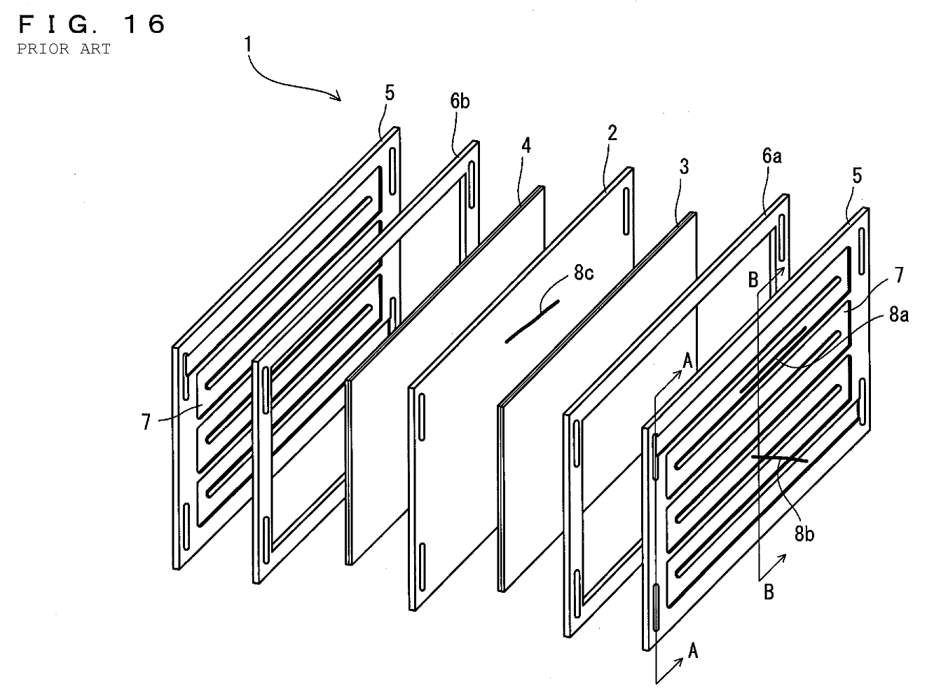

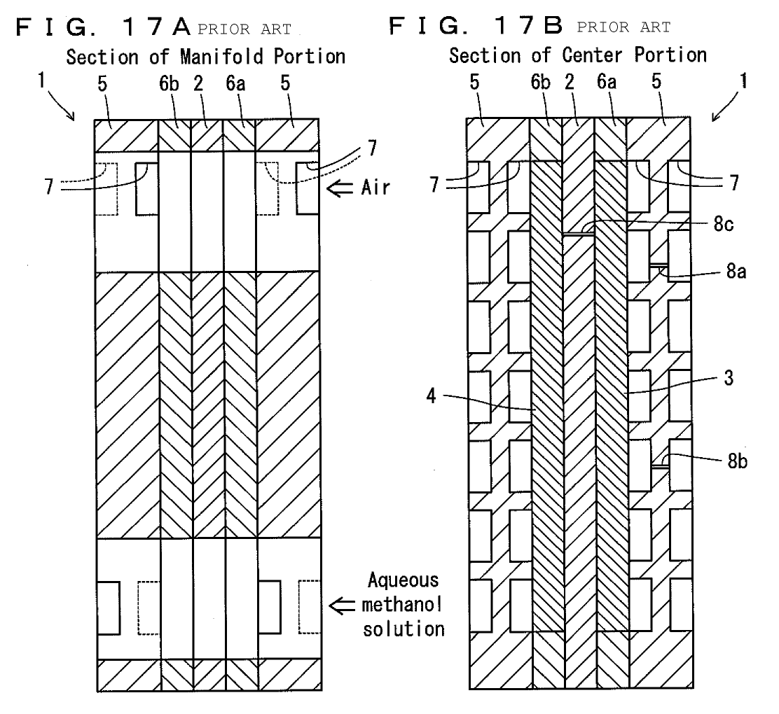

As described, when there is an abnormality in the fuel cell 104 caused by a leakage of aqueous methanol solution from the anode 108 side to the cathode 110 side, the fuel cell system 100 is started by driving the air pump 136 before driving the aqueous solution pump 134. This sequence makes the pressure on the cathode 110 side greater than the pressure on the anode 108 side, and pushes the aqueous methanol solution which comes from the anode 108 side to the cathode 110 side, back to the anode 108 side. In cases where the fuel cell 104 has an undesirable passage such as any breakage (the cracks 8a, 8b and the tear 8c) as shown in FIG. 16, FIG. 17A and FIG. 17B which provides an uncontrolled communication between the anode 108 and the cathode 110, driving the aqueous solution pump 134 first can cause the pressure on the anode 108 side to exceed the pressure on the cathode 110 side, resulting in widening of the passage. As exemplified in the present operation example, however, making the pressure on the cathode 110 side greater than the pressure on the anode 108 side can prevent the widening of the undesirable passage, and minimize leakage of aqueous methanol solution from the anode 108 side to the cathode 110 side. The reducing effect is more remarkable in cases where the aqueous solution pump 134 and the air pump 136 have output settings so that operating the aqueous solution pump 134 and the air pump 136 will create a higher pressure on the anode 108 side than a pressure on the cathode 110 side.

Also, by using different startup sequences of the aqueous solution pump 134 and the air pump 136 depending on the presence and absence of an abnormality in the fuel cells 104, it becomes possible to provide an optimum power generation startup process suitable for the state of the fuel cells 104.

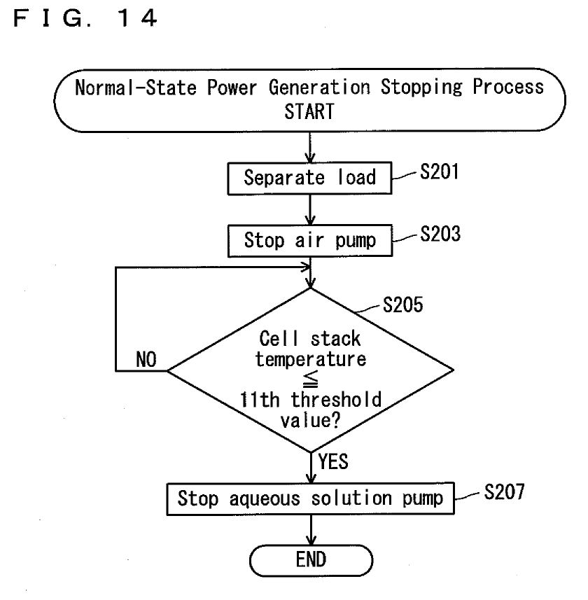

Further, reference will be made to FIG. 14 to describe a power generation stopping process in normal state of the fuel cell system 100 (when the abnormality flag is OFF). This process is commenced when the main switch 142 is turned OFF while the system is in its startup process or in normal operation, with the abnormality flag being in OFF position. Another occasion where this process is commenced is when the charge rate in the secondary battery 130 detected by the charge-amount detector 44 has become not lower than about 98% while the system is in its startup process or in normal operation with the abnormality flag being in OFF position.

First, the CPU 158 turns OFF the ON/OFF circuit 168 to separate the electric motor 38 as the load from the cell stack 102 (Step S201). Then, the CPU 158 stops the air pump 136 (Step S203). The CPU 158 determines whether or not the temperature of the cell stack 102 is not higher than an eleventh threshold value (preferably about 50° C., for example) (Step S205). The CPU 158 waits until the temperature of the cell stack 102 becomes not higher than the eleventh threshold value. When the temperature of the cell stack 102 becomes not higher than the eleventh threshold value, the CPU 158 stops the aqueous solution pump 134 (Step S207), and brings the process to an end.

As described, when the fuel cell 104 is in normal state, the air pump 136 is stopped first. The aqueous solution pump 134 is continued to operate so as to keep the supply of aqueous methanol solution and thereby to lower the temperature of the cell stack 102 down below the eleventh threshold value in a short time. Therefore, the cell stack 102 is cooled quickly, making it possible to stop the power generation quickly and thereby to prevent deterioration of the cell stack 102, particularly deterioration of the platinum catalysts layers 108a and 110a.

Also, the arrangement makes it possible to stop the aqueous solution pump 134 at an earlier timing. This reduces wasting of aqueous methanol solution.

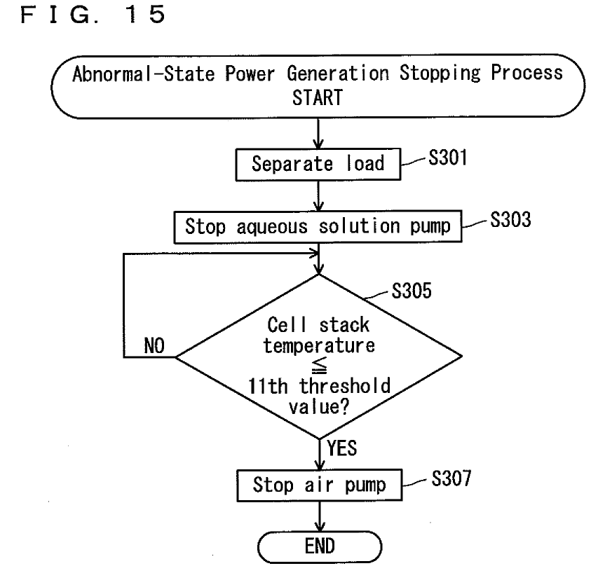

Reference is now made to FIG. 15 to describe a power generation stopping process which is performed when the fuel cell system 100 is in an abnormal state (when the abnormality flag is ON). This process is commenced when the main switch 142 is turned OFF while the system is in its startup process or in normal operation with the abnormality flag being in ON position. Another occasion where this process is commenced is when the charge rate in the secondary battery 130 detected by the charge-amount detector 44 has become not lower than about 98% while the system is in its startup process or in normal operation, with the abnormality flag being in ON position.

First, the CPU 158 turns OFF the ON/OFF circuit 168 to separate the electric motor 38 as the load from the cell stack 102 (Step S301). Then, the CPU 158 stops the aqueous solution pump 134 (Step S303). The CPU 158 determines whether or not the temperature of the cell stack 102 is not higher than the eleventh threshold value (preferably about 50° C., for example) (Step S305). The CPU 158 waits until the temperature of the cell stack 102 becomes not higher than the eleventh threshold value. When the temperature of the cell stack 102 becomes not higher than the eleventh threshold value, the CPU 158 stops the air pump 136 (Step S307), and brings the process to an end.

As described, when there is an abnormality in the fuel cell 104 caused by a leakage of aqueous methanol solution from the anode 108 side to the cathode 110 side, at the time of stopping power generation, the aqueous solution pump 134 is stopped before the air pump 136 is stopped. This makes the pressure on the cathode 110 side greater than the pressure on the anode 108 side, pushes the aqueous methanol solution which comes from the anode 108 side to the cathode 110 side, back to the anode 108 side, and minimizes the leakage of aqueous methanol solution from the anode 108 side to the cathode 110 side. In cases where the fuel cell 104 has an undesirable passage such as any breakage (the cracks 8a, 8b and the tear 8c) as shown in FIG. 16, FIG. 17A and FIG. 17B which provides an uncontrolled communication between the anode 108 and the cathode 110, stopping the air pump 136 first can make the pressure on the anode 108 side greater than the pressure on the cathode 110 side, allowing aqueous methanol solution on the anode 108 side to move through the undesirable passage to the cathode 110, resulting in widening of the undesirable passage. According to the fuel cell system 100 of a preferred embodiment of the present invention, however, the pressure on the cathode 110 side is made to be greater than the pressure on the anode 108 side, so as to prevent the aqueous methanol solution on the anode 108 side from moving through the undesirable passage to the cathode 110. This prevents the widening of the undesirable passage, minimizes leakage of aqueous methanol solution after the power generation has been stopped, and therefore prevents wasting of aqueous methanol solution.

Further, the air pump 136 is stopped after the aqueous solution pump 134 has been stopped, under the condition that the temperature of the fuel cells 104 has become not higher than a predetermined value (the eleventh threshold value). This arrangement allows for sufficient cooling of the fuel cell 104 and particularly sufficient cooling of the platinum catalyst layers 108a and 110a included in the anode 108 and the cathode 110. This makes it possible to keep the platinum catalysts layers 108a and 110a in a desired condition, and to minimize deterioration of the platinum catalysts layers 108a and 110a. The fuel cell system 100 can be used suitably for cases where their normal operation temperature is high (not lower than about 60° C., for example).

Also, by using different shutdown sequences of the aqueous solution pump 134 and the air pump 136 depending on the presence and absence of an abnormality in the fuel cells 104, it becomes possible to provide an optimum power generation stopping process suitable for the state of the fuel cells 104.

A demonstrative experiment revealed that the amount of aqueous methanol solution on the cathode 110 side after power generation stoppage when there is an abnormality in the fuel cell 104 was about 200 cc in a conventional system whereas the amount was reduced to about 50 cc in the present preferred embodiment.

In the preferred embodiments given above, methanol preferably is used as the fuel, and aqueous methanol solution preferably is used as the aqueous fuel solution. However, the present invention is not limited to this, and the fuel may be provided by other alcoholic fuel such as ethanol, and the aqueous fuel solution may be provided by aqueous solution of the alcohol, such as aqueous ethanol solution.

In the preferred embodiments given above, description was made preferably for a case where the cathode 110 in the cell stack 102 (fuel cells 104) is supplied with air. However, the present invention is not limited to this. The present invention is applicable to any cases where the supplied gas contains an oxidizer. In these cases, the gas supply may be provided by any suitable gas supplying pump.

The fuel cell system according to various preferred embodiments of the present invention is applicable not only to motorbikes but also any transportation equipment, including automobiles and marine vessels.

Also, preferred embodiments of the present invention are applicable to stationary type fuel cell systems, and further, portable type fuel cell systems for use in electronic equipment such as personal computers and other mobile devices.

The present invention being thus far described in terms of preferred embodiments, the preferred embodiments may be varied in many ways within the scope and the spirit of the present invention. The scope of the present invention is only limited by the accompanied claims.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A fuel cell system comprising:
a fuel cell including an anode and a cathode;
an aqueous solution supply arranged to supply the anode with aqueous fuel solution;
a gas supply arranged to supply the cathode with a gas containing an oxidizer;
a cell temperature detector arranged to detect a temperature of the fuel cell; and
a controller programmed to stop an operation of the aqueous solution supply, and thereafter to stop an operation of the gas supply when the temperature of the fuel cell detected by the cell temperature detector has reached a temperature not higher than a predetermined value at a time of stopping power generation.

2. The fuel cell system according to claim 1, further comprising an abnormality detector arranged to detect an abnormality in the fuel cell, wherein the controller is programmed to stop an operation of the aqueous solution supply, and thereafter to stop an operation of the gas supply when the temperature of the fuel cell detected by the cell temperature detector has reached a temperature not higher than the predetermined value if an abnormality is detected by the abnormality detector.

3. The fuel cell system according to claim 2, wherein the controller is programmed to stop an operation of the gas supply, and thereafter to stop an operation of the aqueous solution supply when the temperature of the fuel cell detected by the cell temperature detector has reached a temperature not higher than the predetermined value if an abnormality is not detected by the abnormality detector.

4. The fuel cell system according to claim 1, wherein the controller is programmed to drive the gas supply and thereafter to drive the aqueous solution supply at a time of starting the fuel cell system.

5. The fuel cell system according to claim 4, further comprising an abnormality detector arranged to detect an abnormality in the fuel cell, wherein the controller is programmed to drive the gas supply and thereafter to drive the aqueous solution supply at a time of starting the fuel cell system if an abnormality is detected by the abnormality detector.

6. The fuel cell system according to claim 5, wherein the controller is programmed to drive the aqueous solution supply and thereafter to drive the gas supply at a time of starting the fuel cell system if an abnormality is not detected by the abnormality detector.

7. The fuel cell system according to claim 2, further comprising an aqueous solution storage unit arranged to store the aqueous fuel solution, wherein the abnormality detector includes an aqueous solution amount detector arranged to detect an amount of liquid stored in the aqueous solution storage unit, and an abnormality detector arranged to detect an abnormality in the fuel cell based on a detection result of the aqueous solution amount detector.

8. The fuel cell system according to claim 2, further comprising a fuel-cell cell-stack including a plurality of the fuel cells, wherein the abnormality detector includes a voltage detector arranged to detect a voltage of the fuel-cell cell-stack and an abnormality detector arranged to detect an abnormality in the fuel-cell cell-stack based on a detection result of the voltage detector.

9. The fuel cell system according to claim 2, wherein the abnormality detector includes a pressure detector arranged to detect a pressure of at least one of the anode and the cathode, and an abnormality detector arranged to detect an abnormality in the fuel cell based on a detection result of the pressure detector.

10. The fuel cell system according to claim 2, wherein the abnormality detector includes a cathode temperature detector arranged to detect a temperature of the cathode and an abnormality detector arranged to detect an abnormality in the fuel cell based on a detection result of the cathode temperature detector.

11. The fuel cell system according to claim 1, wherein the controller is programmed to stop an operation of the aqueous solution supply, and thereafter to stop an operation of the gas supply when the temperature of the fuel cell detected by the cell temperature detector has reached a temperature not higher than the predetermined value if there is an abnormality in the fuel cell caused by a leakage of the aqueous fuel solution from the anode side to the cathode side.

12. Transportation equipment comprising the fuel cell system according to claim 1.
